(19) United States
(12) Patent Application Publication
(10) Pub. No.: US 2024/0375151 A1
(43) Pub. Date: Nov. 14, 2024

(54) SORTATION FACILITY FOR OUTBOUND LOADING AND DELIVERY OF MIDDLE-MILE AND LAST-MILE ITEMS

(71) Applicant: Target Brands, Inc., Minneapolis, MN (US)

(72) Inventors: Gregory Lisso, Minneapolis, MN (US); Tyler Park, Minneapolis, MN (US); David Sellner, Minneapolis, MN (US); Jonathan Crepeau, Minneapolis, MN (US)

(21) Appl. No.: 18/612,315

(22) Filed: Mar. 21, 2024

Related U.S. Application Data
(60) Provisional application No. 63/465,133, filed on May 9, 2023.

(51) Int. Cl. B07C 3/08; B07C 3/18; B65G 1/04; B65G 1/137

(52) U.S. Cl. CPC B07C 3/08; B07C 3/18; B65G 1/0492; B65G 1/1378

(57) ABSTRACT

Methods, systems, and apparatus, including computer programs encoded on computer storage media, for sorting items to final destinations in a storage facility. The system includes a first staging area configured to receive and stage the inbound items for routing throughout the storage facility; at least one conveyance system configured to route the staged items from the first staging area; a second staging area configured to receive and sort the items based on geographic information along the first path of the conveyance system; an outbound delivery area configured to receive and dispatch the sorted items into one or more delivery vehicles associated with the storage facility; a local delivery staging area configured to receive a second portion of the staged items along a second path of the at least one conveyance system; and a local delivery outbound area configured to receive the sorted items from the local delivery staging area.

### CROSS-REFERENCE TO RELATED APPLICATIONS

This application claims benefit of priority to U.S. Application No. 63/465,133, filed on May 9, 2023. The contents of which are hereby incorporated by reference in its entirety.

### TECHNICAL FIELD

This document generally describes devices, systems, and methods related to sortation facilities, such as warehouses and distribution centers, that consolidate sorting and outbound loading processes for items of different delivery logistics, such as middle-mile items and last-mile items.

### BACKGROUND

Delivery of items are made through a supply chain that consists of various facilities that sort and distribute the items in various paths to end-consumers. For example, the supply chain can include first-mile, middle-mile, and last-mile deliveries, which use different delivery logistics. Facilities have been designed for first-mile, middle-mile, and last-mile deliveries, respectively and separately, to meet such different requirements. For example, first-mile delivery typically involves transporting from manufacturers to warehouses. Middle-mile deliveries can refer to transporting or delivering items between facilities, warehouses, distribution centers, plants, or other supply chain actors that may not include end-consumers. For example, middle-mile deliveries can include transporting items from a storage facility (e.g., warehouse, distribution center) to fulfillment centers or retail facilities, where customers may eventually purchase their items. Last-mile deliveries can include transportation of items from local facilities to end-consumers.

### SUMMARY

The document generally describes techniques for a sortation facility, such as a warehouse, distribution center, storage facility, fulfillment center, or other type of facility, that consolidates sorting and outbound loading processes for items of different delivery logistics all together, such as both middle-mile and last-mile item deliveries. The sortation center can operate as a node in a supply chain and offer streamlined and efficient processing or sorting and outbound loading operations for both the middle-mile and last-mile deliveries. Middle-mile deliveries are handled by third-party shippers (e.g., UPS, FEDEX, USPS) to deliver items from facilities to other facilities closer to final destinations (e.g., end users) in the supply chain. Last-mile deliveries include delivering ordered items directly to end-consumers (e.g., customers) and retail stores using various vehicles including but not limited to delivery trucks, ride-share vehicles, taxis, retailers' own delivery vehicles, motorcycles, mopeds, bicycles, or other suitable manual and/or autonomous vehicles. In addition, the disclosed sortation facility can be uniquely designed to accommodate inbound and outbound items for both middle-mile and last-mile deliveries in the same facility space. In particular, both separate and shared working areas, such as staging areas, can be used for middle-mile and last-mile items. As another example, the sortation facility can include various pathways and use of conveyance systems from a common inbound area to different outbound/loading areas dedicated for middle-mile items and last-mile items, respectively. Sortation processes can be performed at the facility in order to efficiently determine how to route the middle-mile items and the last-mile items to their dedicated, respective outbound/loading areas.

One or more embodiments described herein can include a system for sorting items to final destinations in a storage facility, the system comprising: a first staging area configured to receive inbound items and stage the inbound items for routing throughout the storage facility; at least one conveyance system configured to route the staged items from the first staging area throughout the storage facility; a partition area configured to receive a first portion of the staged items along a first path of the at least one conveyance system, wherein the items received in the partition area are sorted based on geographic information; a second staging area configured to receive the items that are sorted based on the geographic information along the first path of the at least one conveyance system, wherein the items received in the second staging area are sorted for outbound delivery; an outbound delivery area configured to receive the sorted items from the second staging area along the first path of the at least one conveyance system, wherein the received items are dispatched into one or more delivery vehicles associated with the storage facility; a local delivery staging area configured to receive a second portion of the staged items along a second path of the at least one conveyance system, wherein the items received in the local delivery staging area are sorted based on one or more third-party delivery provider criteria; and a local delivery outbound area configured to receive the sorted items from the local delivery staging area along the second path of the at least one conveyance system, wherein the received items are dispatched into one or more delivery vehicles associated with at least one third-party delivery provider.

In some implementations, the embodiments described herein can optionally include one or more of the following features. The geographic information includes zip codes. Items received in the partition area that have a same zip code are grouped together for outbound delivery by at least one delivery vehicle that is assigned a delivery route for the zip code. The one or more third-party delivery provider criteria includes locations of post offices or third-party delivery providers that are within a first threshold distance from a location of the storage facility. The second portion of the staged items are sorted based on their respective delivery locations being within a second threshold distance from the respective locations of post offices or third-party providers. The second portion of the staged items include middle-mile items. The middle-mile items are identified based on a location of the middle-mile items being outside a centroid of the storage facility. The middle-mile items are identified based on a density of demand of the storage facility. An increased demand for the one or more delivery vehicles associated with the storage facility and decreased availability of the one or more delivery vehicles associated with the storage facility causes at least one of the middle-mile items to be identified as the middle-mile items. The first portion of the staged items include last-mile items. The last-mile items are identified based on a delivery location of the last-mile items being within a centroid of the storage facility. The system further comprises a third-party delivery provider staging area configured to receive a third portion of the staged items along the first path or the second path of the at least one conveyance system. The items received at the third-party delivery provider staging area are staged for outbound delivery by at least one delivery vehicle of the at least one third-party delivery provider. The third portion of the staged items include middle-mile items. The third portion of the staged items includes at least one item of the second portion of the staged items. The third-party delivery provider staging area is part of the local delivery staging area. The system further comprises a non-conveyable-items staging area configured to receive a third portion of the staged items along the first path or the second path of the at least one conveyance system. The items received at the non-conveyable-items staging area cannot be conveyed by the at least one conveyance system. The items received at the non-conveyable-items staging area are staged for outbound delivery by the at least one or more delivery vehicles that are associated with the storage facility or the one or more delivery vehicles associated with the at least one third-party delivery provider. The items received at the non-conveyable-items staging area include at least one of polybags, apparel, items that exceed a threshold size, or other items that do not satisfy one or more conveyance criteria. The non-conveyable-items staging area comprises a first staging area for staging at least one of the third portion of the staged items and a second staging area for staging at least another of the third portion of the staged items. The at least one of the third portion of the staged items include items that exceed a threshold size or items that do not satisfy one or more conveyance criteria, and the at least another of the third portion of the staged items include items that are polybags or apparel. The system further comprises a computer system configured to: automatically determine delivery routes for the one or more delivery vehicles associated with the storage facility; and generate instructions to cause at least one of the items received in the second staging area to be sorted into a particular cart for the one or more delivery vehicles based on (i) the delivery routes that are determined and assigned to the one or more delivery vehicles and (ii) location information of the at least one of the items. The system further comprises a computer system configured to determine instructions for causing the at least one conveyance system to route the items throughout the storage facility.

One or more embodiments described herein can include a method for sorting items to final destinations in a storage facility. The method comprises: receiving, in a first staging area of a storage facility, inbound items; staging, in the first staging area, the inbound items for routing throughout the storage facility; routing, by at least one conveyance system in the storage facility, a first portion of the staged items along a first path of the at least one conveyance system to a partition area; sorting, in the partition area, the first portion of the staged items based on geographic information; routing, by the at least one conveyance system in the storage facility, the items that are sorted based on the geographic information along the first path of the at least one conveyance system to a second staging area; sorting, in the second staging area, the received items that are sorted based on the geographic information for outbound delivery; routing, by the at least one conveyance system in the storage facility, the items that are sorted for outbound delivery along the first path of the at least one conveyance system to an outbound delivery area; and dispatching, in the outbound delivery area, the items that are sorted for outbound delivery into one or more delivery vehicles associated with the storage facility.

In some implementations, the embodiments described herein can optionally include one or more of the following features. The method may further comprises: routing, by the at least one conveyance system in the storage facility, a second portion of the staged items along a second path of the at least one conveyance system to a local delivery staging area; sorting, in the local delivery staging area, the second portion of the staged items based on one or more third-party delivery provider criteria; routing, by the at least one conveyance system in the storage facility, the items that are sorted based on the one or more third-party delivery provider criteria along the second path of the at least one conveyance system to a local delivery outbound area; and dispatching, in the local delivery outbound area, the items that are sorted based on the one or more third-party delivery provider criteria into one or more delivery vehicles associated with at least one third-party delivery provider.

The devices, system, and techniques described herein may provide one or more of the following advantages. For example, the disclosed techniques provide for lowering overall supply chain costs. Both ends of the supply chain can be controlled using the improved sortation facility described herein, which can amount to reducing labor costs and other costs associated with moving both middle-mile items and last-mile items to various relevant users in the supply chain. The disclosed techniques also provide improved ability to accept unexpected changes and quickly make adjustments to the supply chain to continue and optimize operations. Combining middle-mile and last-mile operations in the same facility can also provide for streamlined and efficient assignment of tasks to various components in the facility, including automated conveyance systems, facility vehicles (automated, semi-automated, human-operated), and human workers. As a result, facility operations can be optimized, thereby providing efficient service to the relevant users in the supply chain (e.g., end-consumers, retail stores, other facilities). Combining the middle-mile and last-mile operations in the same facility can also provide for flexible, on-demand delivery services, which can help accelerate both distribution process and efficient delivery operations in the supply chain.

As another example, when the middle-mile and last-mile operations are consolidated at the same facility, decisions for both operations can be made together at a substantially same time or during a short period of time to optimize costs or a delivery time on a package-by-package basis. Further, the facility combining the middle-mile and last-mile operations can offer an ability for a carrier network to dynamically make the middle-mile or last-mile moves depending on the service level that is needed to the guest.

The details of one or more implementations are set forth in the accompanying drawings and the description below. Other features and advantages will be apparent from the description and drawings, and from the claims.

### BRIEF DESCRIPTION OF THE DRAWINGS

FIG. 1A is an example sortation facility for performing sortation and outbound loading operations for both middle-mile and last-mile item deliveries.

FIG. 1B illustrates the example sortation facility of FIG. 1A configured to provide both middle-mile and last-mile item deliveries.

FIG. 1C illustrates how distance criteria can be used with the example sortation facility of FIG. 1A to determine middle-mile and last-mile item delivery sorts.

FIG. 2 is a conceptual diagram of a system for determining sort and outbound loading operations for middle-mile and last-mile item deliveries in a same sortation facility.

FIG. 3 is a flowchart of a process for determining sort and outbound loading operations for both middle-mile and last-mile item deliveries in the sortation facility described herein.

FIG. 4 is a flowchart of a process for determining sort and outbound loading operations for last-mile item deliveries in the sortation facility described herein.

FIG. 5 is a schematic diagram that shows an example of a computing device and a mobile computing device.

Like reference symbols in the various drawings indicate like elements.

### DETAILED DESCRIPTION OF ILLUSTRATIVE EMBODIMENTS

This document generally relates to facilities used for handling and performing operations for items of different delivery logistics, such as both middle-mile and last-mile item deliveries. For example, this document describes a sortation facility (e.g., center, storage facility, warehouse, distribution center, fulfillment center) that is specifically designed to receive middle-mile and last-mile items together at a single inbound area, sort those items along different paths defined in the center based on whether the items are middle-mile or last-mile, and load the sorted items into different types of vehicles (e.g., long distance versus short distance vehicles) at different loading areas dedicated to the middle-mile and last-mile items, respectively. Middle-mile items may refer to packages that are being sent to another processing facility before going to a guest. Last mile items may refer to packages that are being loaded into a vehicle destined direct guest delivery.

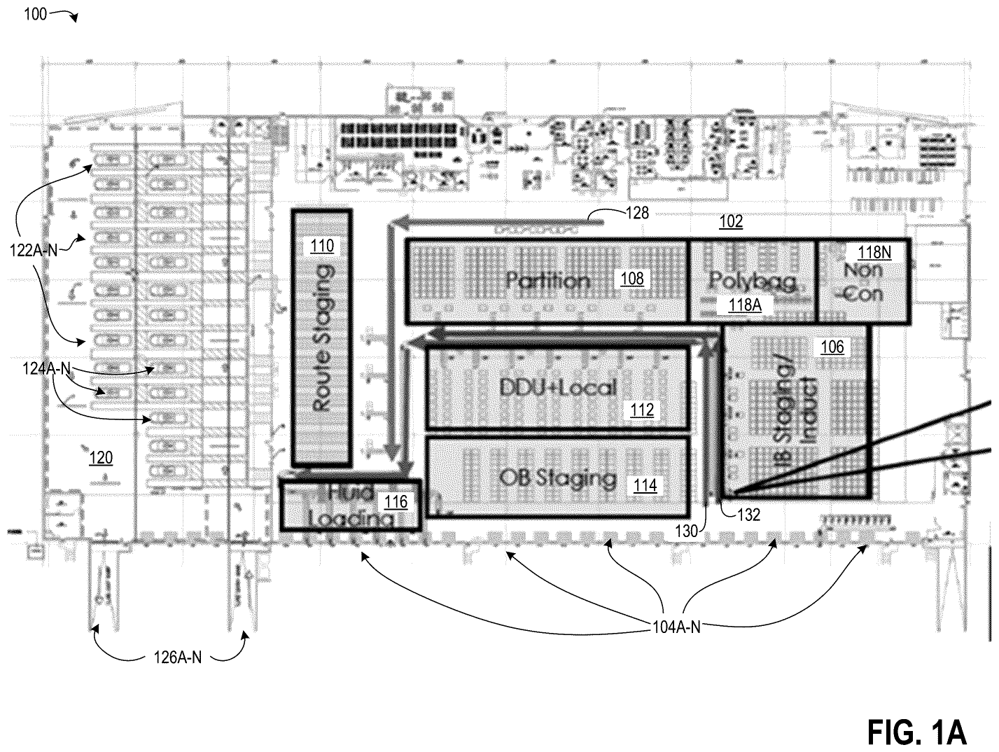

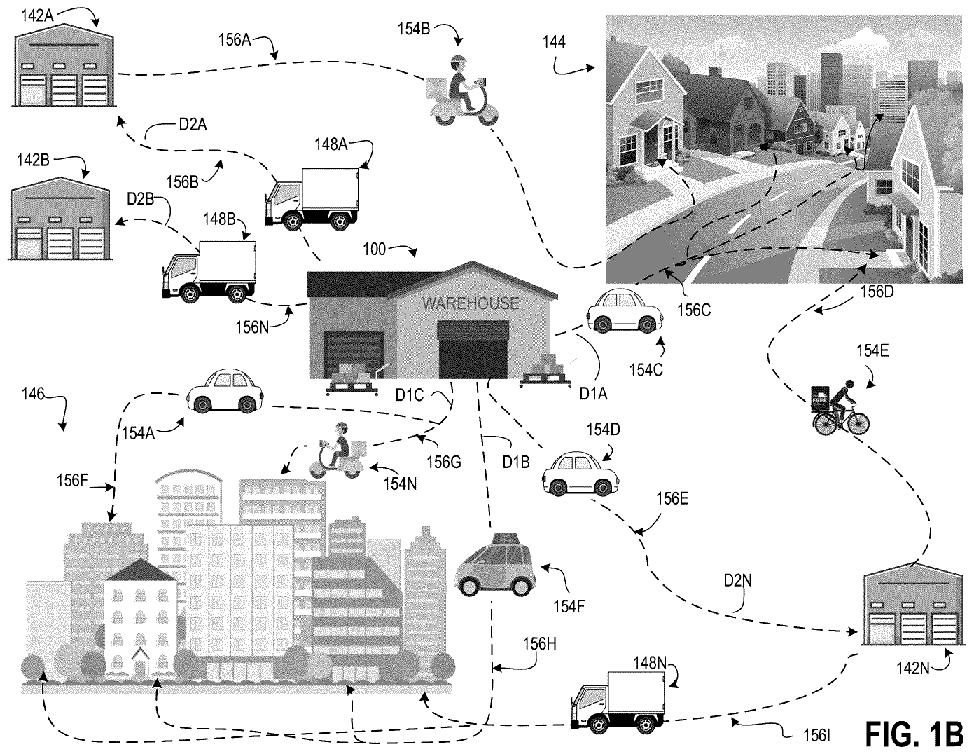

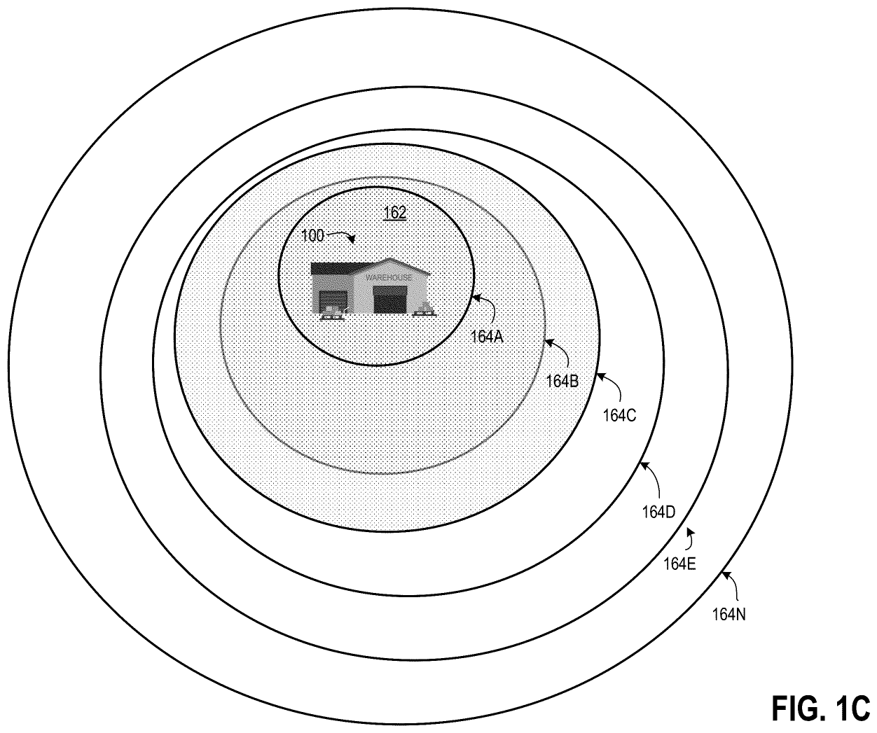

Referring to the figures, FIG. 1A is an example sortation facility 100 for performing sortation and outbound loading operations for both middle-mile and last-mile item deliveries. The sortation facility 100 can be designed and arranged to support handling of operations for both the middle-mile and last-mile item deliveries. In some implementations using the sortation facility 100, the middle-mile and last-mile items can be consolidated in a single inbound area, then sorted out to middle-mile and last-mile staging and/or outbound areas in the facility 100. As described herein, the middle-mile items can include items that are transported between the facility 100 and other supply chain actors, including but not limited to other warehouses, distribution centers, storage facilities, and/or fulfillment centers. Such other supply chain actors may not include final delivery destinations such as end-consumers. Typically, the middle-mile item deliveries can be performed by third-party delivery providers, including but not limited to FEDEX, USPS, UPS, and other commercial or non-commercial delivery services. The last-mile items can include items that are transported or otherwise delivered to end-consumers, retail stores, or other relevant users who purchase or request the items that are stored or otherwise brought into the sortation facility 100. The last-mile item deliveries can be performed by vehicles that are associated with the supply chain or the sortation facility 100, including but not limited to cars, vans, ride-share vehicles, motorcycles, mopeds, and/or bicyclists. Additionally or alternatively, in some implementations, last-mile item deliveries can be performed by third-party delivery providers.

The sortation facility 100 can, in some implementations, be one of the warehouses, distribution centers, storage facilities, or fulfillment centers in the supply chain. For example, an existing distribution center in the supply chain can be retrofitted or otherwise updated to include one or more components described herein for the sortation facility 100. In some implementations, the sortation facility 100 can be a new facility that is introduced into the existing supply chain.

The sortation facility 100 can include an inbound staging area 106, a partition staging area 108, a route staging area 110, a local delivery (DDU/local) staging area 112, an outbound staging area 114, a non-local loading area 116, and other staging areas 118A-N. The other staging areas 118A-N can include a polybag staging area 118A and a non-conveyable items staging area 118N. The sortation facility 100 can include an outbound delivery area 120 having docking bays 122A-N and 126A-N configured to receive delivery vehicles 124A-N. The sortation facility 100 also includes inbound delivery bays 104A-N configured to receive inbound items to the sortation facility 100. Moreover, the sortation facility 100 can include a conveyance system 102 that provides transport of items to one or more of the areas 106-120 described herein.

Inbound items can be received from delivery vehicles at the inbound delivery bays 104A-N. The items can be received from retail stores, distribution centers, warehouses, fulfillment centers, item suppliers, or other supply chain actors. The inbound items can be routed, such as by the conveyance system 102, to the inbound staging area 106, regardless of whether the inbound items are middle-mile items or last-mile items. Both middle-mile and last-mile items can be received at the sortation facility 100 and routed to the inbound staging area 106. This can result in optimized utilization of available resources (e.g., labor, energy) at the sortation facility. In some implementations, one or more of the inbound items can be directly injected into other staging areas that are used for delivering items by third-party delivery providers, such as UPS, to non-local geographic locations. Once the inbound items are received at the inbound staging area 106, the items can be sorted based on whether they are middle-mile or last-mile items.

The configuration of the sortation facility 100 as described herein can provide for multiple sortation processes to be performed to efficiently perform and complete delivery of middle-mile and last-mile items. For example, once an inbound item is identified in the inbound staging area 106 as being a middle-mile item, the middle-mile item can be routed, by the conveyance system 102, to the DDU/local staging area 112 along a conveyance path 130 or to the non-local loading area 116. In the DDU/local staging area 112, the middle-mile item can further be sorted based on geographic information (e.g., zip code) to a particular post office. Once sorted to the particular post office, the middle-mile item can be routed, by the conveyance system 102 along the conveyance path 130, to the outbound staging area 114. The middle-mile items can be held in the outbound staging area 114 until they are ready to be loaded into one or more delivery vehicles 124A-N at one of the docking bays 126A-N and then transported to the particular post office. The delivery vehicle 124A-N that transports the middle-mile item can be associated with a third-party delivery provider, such as FEDEX, USPS, and/or UPS. The third-party delivery provider vehicles 124A-N can be used by the sortation facility 100 for benefits of scale and/or cost. The items sorted in the outbound staging area 114 can be loaded directly into the vehicles 124A-N at the docking bays 126A-N. In some implementations, the items sorted in the outbound staging area 114 can be routed, by the conveyance system 102 along the conveyance path 130, to the non-local loading area 116. Once at the non-local loading area 116, the items can be loaded into the designated vehicles 124A-N at the docking bays 126A-N for delivery to the respective last mile carrier (such as FEDEX, UPS, or other carriers or post offices).

In some examples, the sortation facility 100 can provide three levels of granularity of sort, such as hyper-local, local, and non-local items or volumes. Hyper-local volume can be sorted and delivered by dedicated delivery service (e.g., retailer's last mile delivery service). Local volume can be sorted and sent to the appropriate carrier locations (e.g., USPS DDU location). Finally, non-local volume can be sorted and sent to a separate last mile carrier (e.g., FedEx or UPS). In some cases, the local and non-local volume can be categorized as “middle-mile” as these are not shipped directly to the guests from the sortation center. The hyper-local volume can be considered “last mile”, as this is going directly to a guest from this facility.

Along a conveyance path 132, the local items (e.g., the hyper-local and/or local volumes) can be initially sorted to from inbound. It is a staging area that holds the local items until specific and optimized routes are created based upon the package volume for that day. Once routes are created, the packages are sorted again into their specific routes by being placed onto the conveyor path 128, and ultimately sorted into route staging area 110. These staging areas can create a “pre-sort” so that once routes are finalized the time it takes to sort from the staging location to a final route has a faster cycle time than if there was no pre-sort.

Because of the increased level of sortation capability using the disclosed techniques, the middle-mile item can be transported to the particular post office and thus more quickly and efficiently delivered to the next supply chain actor. In some implementations, the middle-mile item can be delivered to the next supply chain actor on a same day as when the item is sorted in the sortation facility 100 as described herein. Combining the third-party delivery providers with delivery services of the sortation facility 100 or the supply chain as a whole in a singular facility provides benefits of scale as described herein.

Inbound items that are identified as last-mile items in the inbound staging area 106 can be routed, by the conveyance system 102, to the partition staging area 108. For example, the last-mile items can be routed to the partition staging area 108 along a conveyance path 128. In the partition staging area 108, the last-mile items can be further sorted based on their geographic information. For example, the last-mile items can be sorted into delivery groups based on one or more geographic criteria. The one or more geographic criteria can include zip codes, cities, and/or distance from a centroid of other geographic marker, such as a radius, from the sortation facility 100.

The partition-sorted items can then be routed, by the conveyance system 102, to the route staging area 110 from the partition staging area 108 along the conveyance path 128. Efficient last-mile delivery routes can be determined at the route staging area 110, based on the partition sorts for the last-mile items, once all last-mile items have been delivered to the sortation facility 100 within a threshold period of time (e.g., 5 hours, 10 hours, 12 hours, a day, 2 days). The delivery routes determined at the route staging area 110 can further be determined based on one or more other factors and information associated with the last-mile items, such as item package size, item package weight, item destination (e.g., distance relative to other last-mile items, distance relative to a location of the sortation facility 100), etc. The items can further be loaded into delivery route carts in the route staging area 110, then loaded into one or more delivery vehicles 124A-N in the docking bays 122A-N that transport last-mile items. The delivery vehicles 124A-N that transport last-mile items can include a variety of vehicles, including but not limited to vans, cars, ride-share vehicles, delivery vehicles, motorcycles, mopeds, scooters, bicyclists, etc. In some implementations, the delivery vehicles 124A-N that transport the last-mile items can be dispatched from the sortation facility 100 at regular and/or predetermined times. For example, the vehicles 124A-N can be dispatched every 15 minutes, 30 minutes, 1 hour, 2 hours, 4 hours, etc. Increased frequency of dispatching the vehicles 124A-N that transport last-mile items can advantageously reduce delivery and other operational costs for the supply chain as a whole. Additionally, the increased frequency allows for the sortation facility 100 to provide same-day and/or next-day delivery of items to end-consumers, retail stores, and other relevant users in the supply chain.

In some implementations, one or more of the inbound items may not convey well in the sortation facility 100. For example, such items can be too large to fit onto conveyor belts of the conveyance system 102. As another example, such items may be soft or otherwise non-conveyable for some other reason. Such items can be moved (e.g., by workers, by facility vehicles such as forklifts or autonomous vehicles) from the inbound staging area 106 to the polybag staging area 118A and/or the non-conveyable items staging area 118N. In some implementations, these items can be moved directly to the staging areas 118A and/or 118N from the inbound delivery bays 104A-N (instead of being routed first to the inbound staging area 106). Once in the staging areas 118A and/or 118N, the items can be sorted based on whether they are middle-mile items or last-mile items using the disclosed techniques. Items that may be routed to the polybag staging area 118A can include, but are not limited to, polybags, apparel, or other soft items/packages that may not convey well along traditional conveyance systems 102. Items that may be routed to the non-conveyable items staging area 118N can include, but are not limited to, large item packages (e.g., packages that exceed conveyable dimensions for the conveyance system 102), heavyweight packages, etc. The items that are sorted in the staging areas 118A and/or 118N can then be moved accordingly throughout the facility 100 to their respective outbound delivery areas.

FIG. 1A illustrates one example configuration for the sortation facility 100. In some implementations, other sortation facilities can have other configurations. The other configurations can vary based on a size, design, existing configuration, and/or resources available at the respective sortation facilities. Regardless of the configuration of the sortation facility, the disclosed techniques can be implemented in order to consolidate sortation and outbound loading operations for both middle-mile and last-mile items in a single facility.

FIG. 1B illustrates the example sortation facility 100 of FIG. 1A configured to provide both middle-mile and last-mile item deliveries. Various deliveries can be made from the facility 100 along different routes to different destinations and using different types of vehicles. The routes, destinations, and/or types of vehicles may depend on whether the items being delivered are middle-mile or last-mile items.

For example, last-mile items can be delivered directly from the facility 100 to end consumers at homes and/or buildings, in neighborhoods 144 and/or cities 146, along routes 156C, 156F, 156G, and/or 156H that may be less than a threshold distance or otherwise shorter than delivery routes for middle-mile items. The route 156C may, for example, have a length/distance of D1A, the route 156F may have a length/distance of D1B, and the route 156G may have a length/distance of D1C. Any of the distances D1A, D1B, and/or D1C may be within a threshold length or distance for the delivery of last-mile items.

The middle-mile items, on the other hand, can be delivered from the facility 100 to other facilities 142A-N, and may require longer routes than the routes for the last-mile items from the facility 100. For example, the middle-mile items can be delivered from the facility 100 to (i) the other facility 142A along a route 156B having a distance D2A, (ii) the other facility 142B along a route 156N having a distance D2B, and/or (iii) the other facility 142N along a route 156E having a distance D2N. Any of the distances D2A, D2B, and/or D2N can be longer than the distances D1A, D1B, and/or D1C for delivery of last-mile items. This is because in some implementations, middle-mile items may be delivered to the other facilities 142A-N that facilitate delivery of the items to geographic regions that are not within a threshold geographic range or region of the particular storage facility 100. In some implementations, one or more of the other facilities 142A-N may service the same geographic region as the storage facility 100 but may have more resources available and/or be closer to one or more item delivery locations than the storage facility 100. Therefore, items can sometimes be transported to the other facilities 142A-N and then delivered along last-mile delivery routes from the other facilities 142A-N. Once the middle-mile items are delivered to the other facilities 142A-N, the other facilities 142A-N can route those items along their own last-mile item delivery routes, which may include routes 156A, 156D, and/or 156I.

As mentioned above, different types of delivery vehicles can be used for various deliveries depending on whether the items to be delivered are middle-mile or last-mile items. As illustrative, non-limiting examples, container trucks 148A-N and other large delivery vehicles can be used for middle-mile item deliveries, which may include longer delivery routes and/or larger volumes of items for delivery to the other facilities 142A-N. In some implementations, container trucks 148A-N may be used for delivering items to end consumers, especially in scenarios where the container trucks 148A-N are third-party delivery providers including but not limited to UPS, USPS, and/or FEDEX. The facility can also utilize their own vehicles for middle-mile deliveries. As shown in FIG. 1B, the container truck 148N can be used to deliver last-mile items from the other facility 142N to at least one end consumer in the city 146. The items being delivered by the container truck 148N can, for example, include items that exceed threshold size criteria (e.g., furniture, appliances).

Smaller vehicles 154A-N, including but not limited to vans, pickup trucks, cars, ride-share cars, motorcycles, mopeds, scooters, and/or bikes can be used for last-mile item deliveries, which may be delivered along shorter delivery routes, as mentioned above, and/or involve smaller volumes of items for delivery (e.g., same-day delivery of small items to neighbors on one street can be performed with a moped or scooter rather than a delivery van, which can also be beneficial to reduce energy costs and overall carbon footprint) and/or items that satisfy one or more size and/or delivery criteria.

FIG. 1C illustrates how distance criteria can be used with the example sortation facility 100 of FIG. 1A to determine middle-mile and last-mile item delivery sorts. A circle 164A represents a geographic region for the sortation facility 100. In other words, items having delivery locations within the circle 164A can be delivered directly to their locations from the facility 100. These items may include last-mile items. Circles 164B-N represent other geographic regions surrounding the facility 100 where items may be delivered. A distance from a centroid of the circle 164A or the facility 100 to a delivery location of an item in any of the circles 164A-N can be measured and used to determine whether the item is to be sorted for middle-mile deliveries or last-mile deliveries in the facility 100. For example, items having delivery locations within a shaded portion 162 of the circles 164A, 164B, and/or 164C can be sorted as last-mile items and therefore delivered to respective end consumers by vehicles of the facility 100. Items having delivery locations outside of the shaded portion 162, and thus being located in one or the circles 164D-N can be sorted as middle-mile items and delivered to other facilities (and sometimes to end-consumers) by third-party delivery providers.

One or more distance and/or centroid criteria can be used to determine whether the items are to be sorted for last-mile or middle-mile deliveries. The criteria can vary depending on a particular geographic region of the facility 100. For example, the facility 100 can be located in or near a city. Any item having a delivery location within a 30-minute drive from the centroid of the facility 100 can be sorted for last-mile deliveries. These items may also be delivered on a same day, regardless of time of day, since vehicles of the facility 100 can be used to make the last-mile deliveries. Any item having a delivery location that would require more than a 30-minute drive can be sorted as middle-mile deliveries. Therefore, these items may be delivered by the third-party delivery providers.

The criteria can also vary depending on density of demand or availability of resources, such as labor, energy, vehicles, etc. For example, if the facility 100 employs delivery workers who are all out on deliveries but some quantity of items are still at the facility 100 and have a delivery location within the shaded portion 162 of the circles 164A-C, then the facility 100 may switch to using third-party delivery providers, such as a local post office, to deliver the quantity of items still at the facility 100 as soon as possible. The facility 100 can therefore use resources efficiently and ensure that deliveries are made on time to end consumers.

Additional criteria for determining whether items are to be sorted as middle-mile or last-mile deliveries include a general density of deliveries from day to day. This density may be centered around a centroid of the city. The centroid may shift and make certain neighborhoods less desirable to deliver to/from the last mile delivery service. Further, the criteria can include the level of speed that is desired to provide the guest. By way of example, if a very quick delivery to guests (e.g., next day delivery) is desired for more items, more volume can be shifted to the last mile delivery service. If a relatively quick delivery (e.g., two-day delivery speed) is desired for more items, more middle-mile volume can be moved from the sortation center. A goal is to leverage both of these types of moves to deliver to the guest at their desired speed, accurately.

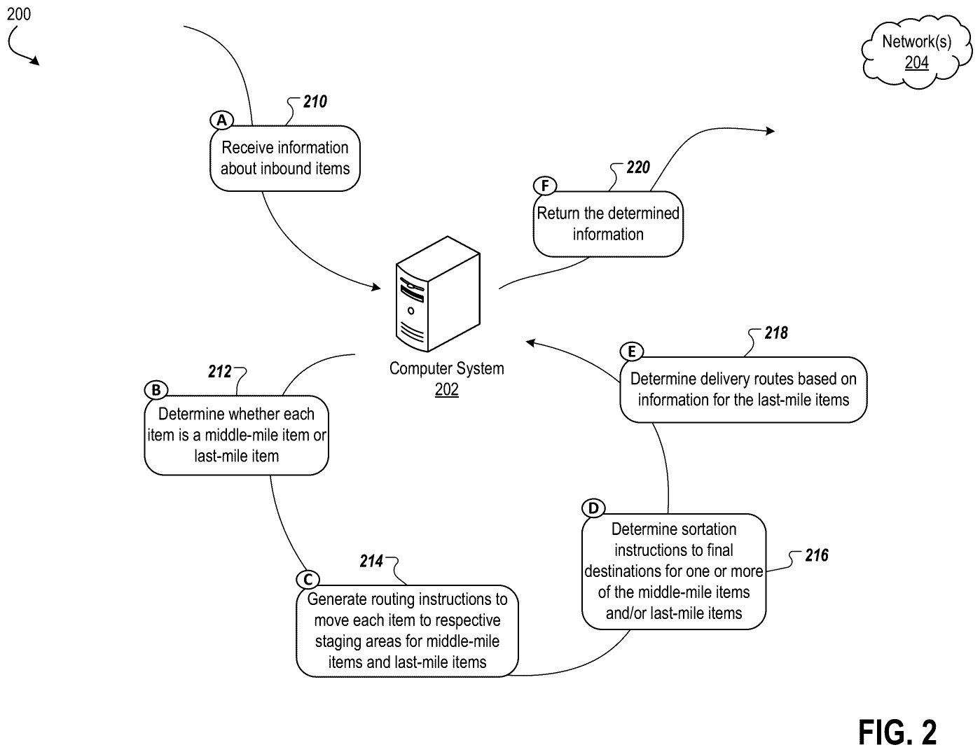

FIG. 2 is a conceptual diagram of a system 200 for determining sort and outbound loading operations for middle-mile and last-mile item deliveries in a same sortation facility. The system 200 can be applied to the sortation facility 100 described in FIGS. 1A-C. The system 200 can also be applied to any other facility described throughout this disclosure.

The system 200 can include a computer system 202 that communicates with various other systems and/or devices via a network(s) 204 (e.g., wired, wireless). The computer system 202 can be any type of computing system, computing device, server, network of devices, network of computer systems, network of servers, and/or cloud-based computing system. The computing system 202 can be configured to perform operations such as determining whether inbound items in a facility (such as the facility 100) should be sorted as middle-mile or last-mile items. The computing system 202 can also perform operations including but not limited to determining how to route middle-mile and last-mile items throughout the facility, determining delivery routes for last-mile items, and/or determining how to pack middle-mile and/or last-mile items in their respective delivery vehicles.

As shown in FIG. 2, the computer system 202 can receive information about inbound items in block A (210). The information can be received from other computer systems, such as computer systems of item providers, shippers, and/or customers/consumers. The information about the items can include, but is not limited to, size/dimensions of the items/packaging of the items, weight of the items, item descriptions, final destinations of the items, requested delivery service(s) for the items, customer/end-consumer information, etc.

The computer system 202 can determine whether each of the inbound item is a middle-mile item or a last-mile item (block B, 212). The computer system 202 can determine whether the item is middle-mile or last-mile based on the information received in block A (210). For example, the computer system 202 can process the information to determine that the item is to be delivered within a threshold distance of a centroid of the facility. The computer system 202 can then identify the item as a last-mile item. On the other hand, if the computer system 202 processes the information and determines that the item is to be delivered to a location that exceeds the threshold distance from the centroid of the facility, the computer system 202 can identify the item as a middle-mile item.

The determination in block B (212) can be made whenever the computer system 202 receives information about the inbound item. In some implementations, this determination can be made in batch for some quantity of inbound items. In other words, block B (212) can be performed by the computer system 202 once the facility receives a threshold quantity of inbound items at the facility. In some implementations, information about the inbound items (block A, 210) can be received before the inbound items arrive at the facility. Then, the determination in block B (212) can be performed before the inbound items arrive or within some threshold amount of time since the items arrive at the facility, which can provide for more efficient and timely determinations to be made. The more efficient and timely determinations can allow for optimization of operations performed within the facility and optimization of available labor and/or energy resources in the facility.

The computer system 202 can generate routing instructions to move each of the inbound items to respective staging areas for middle-mile and last-mile items (block C, 214). This determination can be made based on the determination in block B (212). For example, if the computer system 202 determines that an inbound item is a middle-mile item, then the computer system 202 can generate instructions that cause the conveyance system 102 of the facility 100 to route the middle-mile item from the inbound staging area 106 in FIG. 1A to the DDU/local staging area 112 along the conveyance path 130. As another example, if the computer system 202 determines that the item is a last-mile item, the computer system 202 can generate instructions that cause the conveyance system 102 to route the last-mile item from the inbound staging area 106 to the partition staging area 108 along the conveyance path 128.

In block D (216), the computer system 202 can determine sortation instructions to final destinations for one or more of the middle-mile items and/or last-mile items. For middle-mile items, this determination can include identifying, based on zip codes or other geographic information for the middle-mile items, local post offices that service delivery locations of the middle-mile items and sorting or grouping the middle-mile items based on the identified post offices. For last-mile items, this determination can include sorting or grouping the items in the partition staging area 108 based on zip code or other geographic information.

The determinations performed in block D (216) can also include generating additional instructions for routing the respective items through the facility to complete outbound preparation and/or delivery of the items. For example, the computer system 202 can generate instructions that cause the conveyance system 102 to route the sorted middle-mile items from the DDU/local staging area 112 to the outbound staging area 114 and/or the non-local loading area 116 and to designated delivery vehicles of third-party delivery providers along the conveyance path 130. The computer system 202 can generate instructions that cause the conveyance system 102 to route the sorted last-mile items from the partition staging area 108 to the route staging area 110 and then to outbound delivery vehicles associated with the facility 100 along the conveyance path 128.

The computer system 202 can determine delivery routes based on information for the last-mile items (block E, 218). Determining the delivery routes can depend on a variety of factors, including but not limited to size and/or weight of the last-mile items, selected delivery service for the items, delivery destination for the items, availability of delivery vehicles and/or delivery workers at the facility, traffic and/or weather conditions, expected or actual busyness of the facility, etc. This determination can be performed once the last-mile items are routed to the route staging area 110 in the facility 100. This determination can be performed once all inbound items have been received at the facility 100 within a threshold period of time (e.g., 1 hour, 4 hours, 12 hours, 24 hours, etc.). This determination can be performed once a threshold quantity of last-mile items satisfying one or more delivery criteria are identified and/or received at the route staging area 110 (e.g., a threshold quantity of items to be delivered within a same geographic region or zip code are received at the route staging area 110).

In block F (220), the computer system 202 returns the determined information. The information can be returned in real-time or near real-time as it is determined by the computer system 202. The computer system 202 can return any one or more of the determinations made in blocks B, C, D, and/or E (212, 214, 216, 218, respectively). The information can be returned to one or more different computer systems, devices, and/or components in the facility. For example, the routing instructions determined in block C (214) ca be returned to a controller that controls the conveyance system 102 in the facility 100. As another example, the sortation instructions determined in block D (216) can be returned to a computing device of a facility worker who packs the items into carts and/or outbound delivery vehicles. As yet another example, the delivery routes determined in block E (218) can be returned to computing devices of outbound delivery vehicles and/or delivery workers. The determined information can also be transmitted to a data store for storage and/or later retrieval/processing.

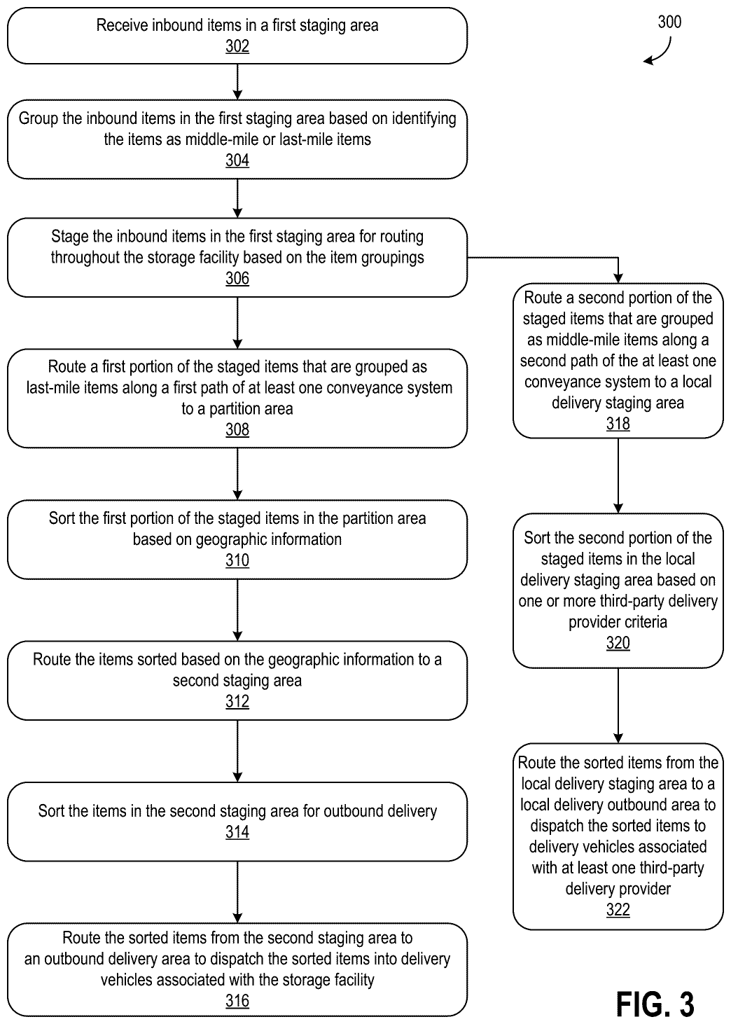

FIG. 3 is a flowchart of a process 300 for determining sort and outbound loading operations for both middle-mile and last-mile item deliveries in the sortation facility described herein. In some implementations, the process 300 can be performed by the computer system 202. The process 300 can also be performed by one or more other computing systems, devices, computers, networks, cloud-based systems, and/or cloud-based services.

Referring to the process 300 in FIG. 3, inbound items are received in a first staging area in block 302. The first staging area can be configured to receive the inbound items and stage the inbound items for routing throughout the storage facility. Refer to the inbound staging area 106 in the example facility 100 of FIG. 1A.

In block 304, the inbound items are grouped in the first staging area based on identifying the items as middle-mile or last-mile items. The middle-mile items can be identified based on a location of the middle-mile items being outside a centroid of the storage facility. The middle-mile items can be identified based on a density of demand of the storage facility. For example, an increased demand for the one or more delivery vehicles associated with the storage facility and decreased availability of the one or more delivery vehicles associated with the storage facility may cause at least one of the middle-mile items to be identified as the middle-mile items. The last-mile items can be identified based on a delivery location of the last-mile items being within a centroid of the storage facility. Refer to FIGS. 1A-C for further discussion about identifying middle-mile and last-mile items.

The inbound items are staged in the first staging area for routing throughout the storage facility based on the item groupings (block 306). In other words, middle-mile items can be grouped together in the first staging area to then be routed to designated areas in the storage facility for middle-mile items. Last-mile items can be grouped together in the first staging area to then be routed to designated areas in the storage facility for last-mile items.

The process 300 can then continue to block 308 and/or block 318. The process 300 continues to block 308 for last-mile items and the process 300 continues to block 318 for middle-mile items.

Referring first to last-mile items, after block 306, a first portion of the staged items that are grouped as last-mile items are routed along a first path of at least one conveyance system to a partition area in block 308. Refer to the partition staging area 108 and the conveyance path 128 described in FIG. 1A. The at least one conveyance system can be configured to route the staged items from the first staging area throughout the storage facility. The partition area can be configured to receive a first portion of the staged items along a first path of the at least one conveyance system. The first portion of the staged items can include items that were identified as last-mile items and grouped together as such in the first staging area.

Then, the first portion of the staged items is sorted in the partition area based on geographic information (block 310). The geographic information can include zip codes. Items received in the partition area that have a same zip code can be grouped together for outbound delivery by at least one delivery vehicle that is assigned a delivery route for the zip code. As described herein, the at least one delivery vehicle can be a vehicle associated with the storage facility, such as a ride-share vehicle, scooter, moped, motorcycle, bicycle, car, and/or van.

The items sorted based on the geographic information are then routed to a second staging area (block 312). The second staging area can be configured to receive the items that are sorted based on the geographic information along the first path of the at least one conveyance system. The second staging area can include the route staging area 110 described in FIG. 1A.

In block 314, the items are sorted in the second staging area for outbound delivery. For example, techniques can be performed to group or sort the items in the second staging area according to one or more delivery routes. The delivery routes can be determined based on location information associated with each of the items that have been sorted based on their geographic information. The delivery routes can also be determined based on availability of vehicles associated with the facility and/or labor/energy resources to deliver the items that have been sorted based on their geographic information.

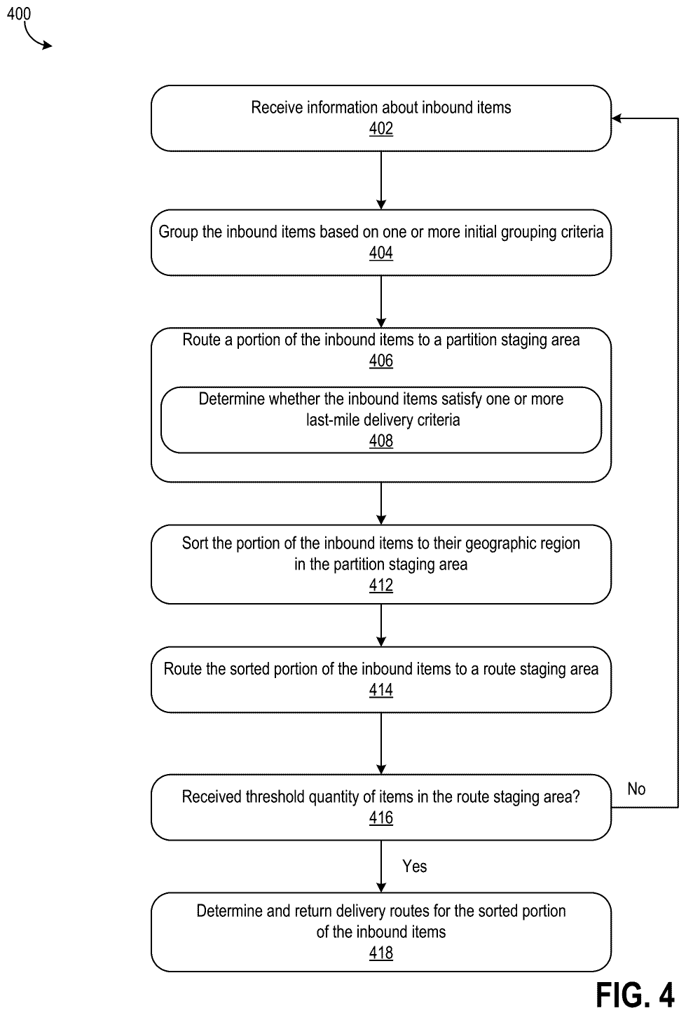

The sorted items are then routed from the second staging area to an outbound delivery area to dispatch the sorted items into delivery vehicles associated with the storage facility (block 316). The outbound delivery area can be configured to receive the sorted items from the second staging area along the first path of the at least one conveyance system. The received items can be dispatched into one or more delivery vehicles associated with the storage facility. The outbound delivery area can include the route staging area 110 shown in FIG. 1A. The outbound delivery area can include the outbound delivery area 120 having the docking bays 122A-N as shown and described in FIG. 1A. The items can be sorted in the route staging area 110 based on their respective delivery routes. For each delivery route, the items can be arranged in order from first to be delivered to last to be delivered (or vice versa). The items for the delivery route can then be loaded into a vehicle assigned the delivery route according to the item arrangement. Refer to process 400 in FIG. 4 for further discussion about sorting last-mile delivery items.

Referring to middle-mile items, after block 306, a second portion of the staged items that are grouped as middle-mile items are routed along a second path of the at least one conveyance system to a local delivery staging area in block 318. The local delivery staging area can be configured to receive a second portion of the staged items along a second path of the at least one conveyance system. The second portion of the staged items can include middle-mile items, as described herein. The local delivery staging area can include the DDU/local staging area 112 described in FIG. 1A. The second path of the at least one conveyance system can be the conveyance path 130 described in FIG. 1A.

The second portion of the staged items are sorted in the local delivery staging area based on one or more third-party delivery provider criteria (block 320). The one or more third-party delivery provider criteria can include locations of post offices and/or third-party delivery providers that may be within a first threshold distance from a location of the storage facility. The second portion of the staged items can be sorted based on their respective delivery locations being within a second threshold distance from the respective locations of post offices and/or third-party providers. The second portion of the staged items can be sorted based on which post offices they should be delivered to. An item can be sorted for a particular post office that services a delivery location of the item. Similarly, an item can be sorted for a particular third-party delivery provider that offers delivery services to a delivery location of the item.

The sorted items are then routed from the local delivery staging area to a local delivery outbound area to dispatch the sorted items to delivery vehicles associated with at least one third-party delivery provider (block 322). The local delivery outbound area can be configured to receive the sorted items from the local delivery staging area along the second path of the at least one conveyance system. The received items can be dispatched into one or more delivery vehicles associated with at least one third-party delivery provider. The local delivery outbound area can include the outbound staging area 114 and/or the non-local loading area 116 of the facility 100 in FIG. 1A.

In some implementations, as described in reference to FIG. 2, a computer system can perform one or more of the disclosed techniques. For example, the computer system can automatically determine delivery routes for the one or more delivery vehicles associated with the storage facility. The computer system can generate instructions to cause at least one of the items received in the second staging area to be sorted into a particular cart for the one or more delivery vehicles based on (i) the delivery routes that are determined and assigned to the one or more delivery vehicles and/or (ii) location information of the at least one of the items. The computer system can also determine instructions for causing the at least one conveyance system to route the items described herein throughout the storage facility.

In some implementations, the facility can also include a third-party delivery provider staging area that can be configured to receive a third portion of the staged items along the first path or the second path of the at least one conveyance system. The items received at the third-party delivery provider staging area can be staged for outbound delivery by at least one delivery vehicle of the at least one third-party delivery provider. The third portion of the staged items can include middle-mile items. The third portion of the staged items can include at least one item of the second portion of the staged items. The third-party delivery provider staging area can be part of the local delivery staging area, in some implementations. In yet some implementations, the third-party delivery provider staging area can include the outbound staging area 114 and/or the non-local loading area 116 of the facility 100 in FIG. 1A.

In yet some implementations, the facility can additionally or alternatively include a non-conveyable-items staging area that can be configured to receive a third portion of the staged items along the first path or the second path of the at least one conveyance system. The non-conveyable-items staging area can include any one or more of the staging areas 118A-N in the facility 100 described in reference to FIG. 1A. The items received at the non-conveyable-items staging area may not be conveyed by the at least one conveyance system. The items received at the non-conveyable-items staging area can be staged for outbound delivery by the at least one or more delivery vehicles that are associated with the storage facility or the one or more delivery vehicles associated with the at least one third-party delivery provider. The items received at the non-conveyable-items staging area may include at least one of polybags, apparel, items that exceed a threshold size, and/or other items that do not satisfy one or more conveyance criteria. The non-conveyable-items staging area can include a first staging area for staging at least one of the third portion of the staged items and a second staging area for staging at least another of the third portion of the staged items. The at least one of the third portion of the staged items may include items that exceed a threshold size or items that do not satisfy one or more conveyance criteria, and the at least another of the third portion of the staged items may include items that are polybags or apparel.

FIG. 4 is a flowchart of a process 400 for determining sort and outbound loading operations for last-mile item deliveries in the sortation facility described herein. In some implementations, the process 400 can be performed by the computer system 202. The process 400 can also be performed by one or more other computing systems, devices, computers, networks, cloud-based systems, and/or cloud-based services.

Referring to the process 400 in FIG. 4, information about inbound items can be received in block 402. The information received can include delivery information, such as an address, zip code, or other delivery location associated with the inbound items. Refer to block A (210) described in reference to FIG. 2 for further discussion about the information received about the inbound items.

In block 404, the inbound items can be grouped based on one or more initial grouping criteria. The initial grouping criteria can be used to determine whether the items are middle-mile or last-mile items. Using the criteria, for example, items that are to be delivered to secondary facilities (e.g., distribution centers, fulfillment centers, warehouses) can be grouped as middle-mile items. Using the criteria, items that are to be delivered to end consumers and/or retail stores can be grouped as last-mile items. In some implementations, using the criteria, items that are to be delivered to locations within a threshold distance from the facility (e.g., a centroid of the facility) can be grouped as last-mile items. On the other hand, using the criteria, items that are to be delivered to locations outside the threshold distance from the facility can be grouped together as middle-mile items. Various other criteria can be used in block 404.

A portion of the inbound items can be routed to a partition staging area in block 406. It can be determined whether the inbound items satisfy one or more last-mile delivery criteria (block 408). The portion of items that are routed to the partition staging area can include items that were initially grouped as last-mile items (e.g., based on the inbound items satisfying the one or more last-mile delivery criteria in block 408).

The portion of the inbound items are sorted to their geographic region in the partition staging area in block 412. As described herein, the last-mile items can be sorted based on their zip code or other delivery location information. Items that are to be delivered in a particular zip code can be grouped together. Items that are to be delivered within a particular threshold distance from the centroid of the facility can also be grouped together.

The sorted portion of the inbound items can then be routed to a route staging area in block 414. For example, items that were grouped together for a particular zip code can be routed to the route staging area together using the disclosed techniques (e.g., by the conveyance system 102 in FIG. 1A).

It can be determined whether a threshold quantity of items have been received in the route staging area (block 416). For example, it can be determined whether all inbound items have arrived at the facility and/or no more inbound items are expected for the day or some other predetermined period of time (e.g., a next hour, a next 4 hours, a next 8 hours, a next 12 hours). As another example, it can be determined whether all items grouped as last-mile items for a particular zip code or geographic location/region have been received in the facility and/or in the route staging area. If all of the items for the particular zip code have been received, then block 418 can be performed.

If the threshold quantity of items are received, delivery routes can be determined and returned for the sorted portion of the inbound items in the route staging area (block 418). Using the techniques described herein, a delivery route can be determined for a group of last-mile items being delivered within a same zip code or other geographic location/region. The delivery route can be determined based on a variety of factors, including but not limited to type of delivery that was selected for each of the items (e.g., same-day delivery, one-day delivery, two-day delivery), delivery location of each item relative to each other and/or a location of the facility, availability of delivery vehicles, and/or other labor/energy resource availability.

Returning the determined delivery routes can include providing the delivery routes to one or more delivery vehicles associated with the facility. The routes can also be returned to one or more workers, delivery workers, or other relevant users associated with the facility. For example, workers can receive the delivery routes and related instructions to determine how to pack the items into the respective delivery vehicle(s) for outbound delivery. As another example, delivery workers can receive the delivery routes and related instructions in order to know how to perform the deliveries efficiently.

If the threshold quantity of the items are not received in the route staging area in block 416, then the process 400 can return to block 402 and continue through the process 400 until the threshold quantity of items are received in the route staging area. In other words, delivery routes may not be determined for the items received in the route staging area until all inbound items have arrived at the facility and been sorted as last-mile or middle-mile items. As a result, delivery route determinations can be made efficiently and with fewer compute and/or processing resources than if the delivery routes are determined continuously and/or in real or near real-time.

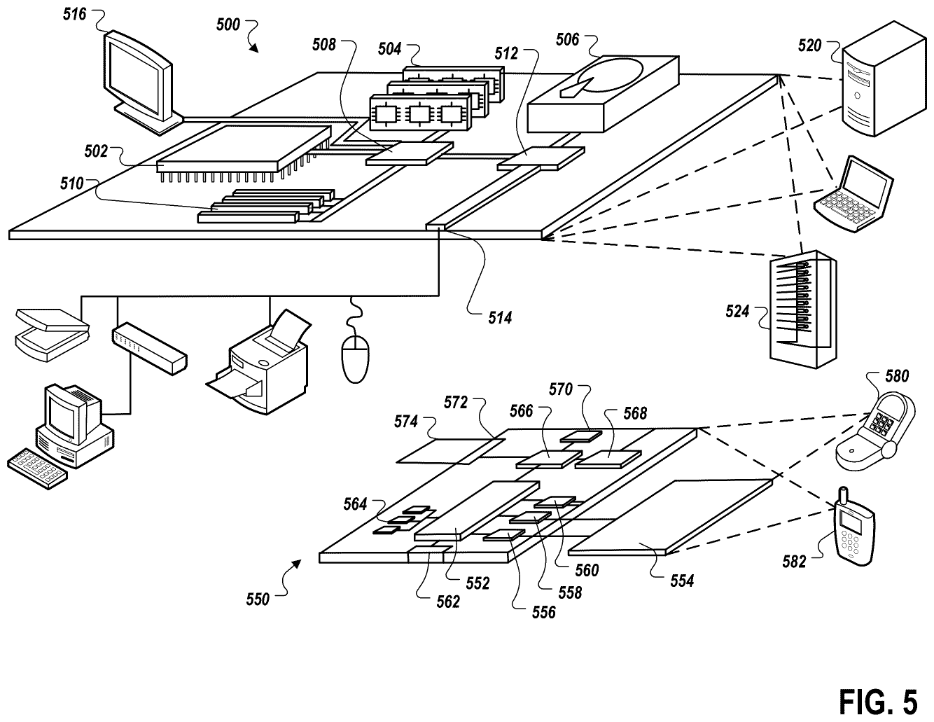

FIG. 5 shows an example of a computing device 500 and an example of a mobile computing device that can be used to implement the techniques described here. The computing device 500 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and can be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 can also be another form of computer-readable medium, such as a magnetic or optical disk.

The storage device 506 is capable of providing mass storage for the computing device 500. In some implementations, the storage device 506 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 504, the storage device 506, or memory on the processor 502.

The high-speed interface 508 manages bandwidth-intensive operations for the computing device 500, while the low-speed interface 512 manages lower bandwidth-intensive operations. Such allocation of functions is exemplary only. In some implementations, the high-speed interface 508 is coupled to the memory 504, the display 516 (e.g., through a graphics processor or accelerator), and to the high-speed expansion ports 510, which can accept various expansion cards (not shown). In the implementation, the low-speed interface 512 is coupled to the storage device 506 and the low-speed expansion port 514. The low-speed expansion port 514, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 500 can be implemented in a number of different forms, as shown in the figure. For example, it can be implemented as a standard server 520, or multiple times in a group of such servers. In addition, it can be implemented in a personal computer such as a laptop computer 522. It can also be implemented as part of a rack server system 524. Alternatively, components from the computing device 500 can be combined with other components in a mobile device (not shown), such as a mobile computing device 550. Each of such devices can contain one or more of the computing device 500 and the mobile computing device 550, and an entire system can be made up of multiple computing devices communicating with each other.

The mobile computing device 550 includes a processor 552, a memory 564, an input/output device such as a display 554, a communication interface 566, and a transceiver 568, among other components. The mobile computing device 550 can also be provided with a storage device, such as a micro-drive or other device, to provide additional storage. Each of the processor 552, the memory 564, the display 554, the communication interface 566, and the transceiver 568, are interconnected using various buses, and several of the components can be mounted on a common motherboard or in other manners as appropriate.

The processor 552 can execute instructions within the mobile computing device 550, including instructions stored in the memory 564. The processor 552 can be implemented as a chipset of chips that include separate and multiple analog and digital processors. The processor 552 can provide, for example, for coordination of the other components of the mobile computing device 550, such as control of user interfaces, applications run by the mobile computing device 550, and wireless communication by the mobile computing device 550.

The processor 552 can communicate with a user through a control interface 558 and a display interface 556 coupled to the display 554. The display 554 can be, for example, a TFT (Thin-Film-Transistor Liquid Crystal Display) display or an OLED (Organic Light Emitting Diode) display, or other appropriate display technology. The display interface 556 can comprise appropriate circuitry for driving the display 554 to present graphical and other information to a user. The control interface 558 can receive commands from a user and convert them for submission to the processor 552. In addition, an external interface 562 can provide communication with the processor 552, so as to enable near area communication of the mobile computing device 550 with other devices. The external interface 562 can provide, for example, for wired communication in some implementations, or for wireless communication in other implementations, and multiple interfaces can also be used.

The memory 564 stores information within the mobile computing device 550. The memory 564 can be implemented as one or more of a computer-readable medium or media, a volatile memory unit or units, or a non-volatile memory unit or units. An expansion memory 574 can also be provided and connected to the mobile computing device 550 through an expansion interface 572, which can include, for example, a SIMM (Single In Line Memory Module) card interface. The expansion memory 574 can provide extra storage space for the mobile computing device 550, or can also store applications or other information for the mobile computing device 550. Specifically, the expansion memory 574 can include instructions to carry out or supplement the processes described above, and can include secure information also. Thus, for example, the expansion memory 574 can be provide as a security module for the mobile computing device 550, and can be programmed with instructions that permit secure use of the mobile computing device 550. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 564, the expansion memory 574, or memory on the processor 552. In some implementations, the computer program product can be received in a propagated signal, for example, over the transceiver 568 or the external interface 562.

The mobile computing device 550 can communicate wirelessly through the communication interface 566, which can include digital signal processing circuitry where necessary. The communication interface 566 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 568 using a radio-frequency. In addition, short-range communication can occur, such as using a Bluetooth, WiFi, or other such transceiver (not shown). In addition, a GPS (Global Positioning System) receiver module 570 can provide additional navigation- and location-related wireless data to the mobile computing device 550, which can be used as appropriate by applications running on the mobile computing device 550.

The mobile computing device 550 can also communicate audibly using an audio codec 560, which can receive spoken information from a user and convert it to usable digital information. The audio codec 560 can likewise generate audible sound for a user, such as through a speaker, e.g., in a handset of the mobile computing device 550. Such sound can include sound from voice telephone calls, can include recorded sound (e.g., voice messages, music files, etc.) and can also include sound generated by applications operating on the mobile computing device 550.

The mobile computing device 550 can be implemented in a number of different forms, as shown in the figure. For example, it can be implemented as a cellular telephone 580. It can also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A system for sorting items to final destinations in a storage facility, the system comprising:
a first staging area configured to receive inbound items and stage the inbound items for routing throughout the storage facility;
at least one conveyance system configured to route the staged items from the first staging area throughout the storage facility;
a partition area configured to receive a first portion of the staged items along a first path of the at least one conveyance system, wherein the items received in the partition area are sorted based on geographic information;
a second staging area configured to receive the items that are sorted based on the geographic information along the first path of the at least one conveyance system, wherein the items received in the second staging area are sorted for outbound delivery;
an outbound delivery area configured to receive the sorted items from the second staging area along the first path of the at least one conveyance system, wherein the received items are dispatched into one or more delivery vehicles associated with the storage facility;
a local delivery staging area configured to receive a second portion of the staged items along a second path of the at least one conveyance system, wherein the items received in the local delivery staging area are sorted based on one or more third-party delivery provider criteria; and
a local delivery outbound area configured to receive the sorted items from the local delivery staging area along the second path of the at least one conveyance system, wherein the received items are dispatched into one or more delivery vehicles associated with at least one third-party delivery provider.

2. The system of claim 1, wherein the geographic information includes zip codes, and wherein items received in the partition area that have a same zip code are grouped together for outbound delivery by at least one delivery vehicle that is assigned a delivery route for the zip code.

3. The system of claim 1, wherein the one or more third-party delivery provider criteria includes locations of post offices or third-party delivery providers that are within a first threshold distance from a location of the storage facility, and wherein the second portion of the staged items are sorted based on their respective delivery locations being within a second threshold distance from the respective locations of post offices or third-party providers.

4. The system of claim 1, wherein the second portion of the staged items include middle-mile items.

5. The system of claim 4, wherein the middle-mile items are identified based on a location of the middle-mile items being outside a centroid of the storage facility.

6. The system of claim 5, wherein the middle-mile items are identified based on a density of demand of the storage facility, wherein an increased demand for the one or more delivery vehicles associated with the storage facility and decreased availability of the one or more delivery vehicles associated with the storage facility causes at least one of the middle-mile items to be identified as the middle-mile items.

7. The system of claim 1, wherein the first portion of the staged items include last-mile items.

8. The system of claim 7, wherein the last-mile items are identified based on a delivery location of the last-mile items being within a centroid of the storage facility.

9. The system of claim 1, wherein the system further comprises a third-party delivery provider staging area configured to receive a third portion of the staged items along the first path or the second path of the at least one conveyance system, wherein the items received at the third-party delivery provider staging area are staged for outbound delivery by at least one delivery vehicle of the at least one third-party delivery provider.

10. The system of claim 9, wherein the third portion of the staged items include middle-mile items.

11. The system of claim 9, wherein the third portion of the staged items includes at least one item of the second portion of the staged items.

12. The system of claim 9, wherein the third-party delivery provider staging area is part of the local delivery staging area.

13. The system of claim 1, wherein the system further comprises a non-conveyable-items staging area configured to receive a third portion of the staged items along the first path or the second path of the at least one conveyance system, wherein the items received at the non-conveyable-items staging area cannot be conveyed by the at least one conveyance system, wherein the items received at the non-conveyable-items staging area are staged for outbound delivery by the at least one or more delivery vehicles that are associated with the storage facility or the one or more delivery vehicles associated with the at least one third-party delivery provider.

14. The system of claim 13, wherein the items received at the non-conveyable-items staging area include at least one of polybags, apparel, items that exceed a threshold size, or other items that do not satisfy one or more conveyance criteria.

15. The system of claim 13, wherein the non-conveyable-items staging area comprises a first staging area for staging at least one of the third portion of the staged items and a second staging area for staging at least another of the third portion of the staged items.

16. The system of claim 15, wherein the at least one of the third portion of the staged items include items that exceed a threshold size or items that do not satisfy one or more conveyance criteria, and the at least another of the third portion of the staged items include items that are polybags or apparel.

17. The system of claim 1, wherein the system further comprises a computer system configured to:
automatically determine delivery routes for the one or more delivery vehicles associated with the storage facility; and
generate instructions to cause at least one of the items received in the second staging area to be sorted into a particular cart for the one or more delivery vehicles based on (i) the delivery routes that are determined and assigned to the one or more delivery vehicles and (ii) location information of the at least one of the items.

18. The system of claim 1, wherein the system further comprises a computer system configured to determine instructions for causing the at least one conveyance system to route the items throughout the storage facility.

19. A method for sorting items to final destinations in a storage facility, the method comprising:
receiving, in a first staging area of a storage facility, inbound items;
staging, in the first staging area, the inbound items for routing throughout the storage facility;
routing, by at least one conveyance system in the storage facility, a first portion of the staged items along a first path of the at least one conveyance system to a partition area;
sorting, in the partition area, the first portion of the staged items based on geographic information;
routing, by the at least one conveyance system in the storage facility, the items that are sorted based on the geographic information along the first path of the at least one conveyance system to a second staging area;
sorting, in the second staging area, the received items that are sorted based on the geographic information for outbound delivery;
routing, by the at least one conveyance system in the storage facility, the items that are sorted for outbound delivery along the first path of the at least one conveyance system to an outbound delivery area; and
dispatching, in the outbound delivery area, the items that are sorted for outbound delivery into one or more delivery vehicles associated with the storage facility.

20. The method of claim 19, further comprising:
routing, by the at least one conveyance system in the storage facility, a second portion of the staged items along a second path of the at least one conveyance system to a local delivery staging area;
sorting, in the local delivery staging area, the second portion of the staged items based on one or more third-party delivery provider criteria;
routing, by the at least one conveyance system in the storage facility, the items that are sorted based on the one or more third-party delivery provider criteria along the second path of the at least one conveyance system to a local delivery outbound area; and
dispatching, in the local delivery outbound area, the items that are sorted based on the one or more third-party delivery provider criteria into one or more delivery vehicles associated with at least one third-party delivery provider.
